(19) United States
(12) Patent Application Publication
(10) Pub. No.: US 2015/0147375 A1
(43) Pub. Date: May 28, 2015

(54) NON-STICKY ANTIMICROBIAL MEDICAL ARTICLES

(71) Applicant: Medline Industries, Inc., Mundelein, IL (US)

(72) Inventor: David Jaeger, Spring Grove, IL (US)

(73) Assignee: Medline Industries, Inc., Mundelein, IL (US)

(21) Appl. No.: 14/134,208

(22) Filed: Dec. 19, 2013

Related U.S. Application Data
(60) Provisional application No. 61/909,851, filed on Nov. 27, 2013.

(51) Int. Cl. A01N 55/00; A01N 37/50

(52) U.S. Cl. CPC A01N 55/00; A01N 37/50
USPC 424/411; 514/63; 427/2.1

(57) ABSTRACT

The present invention relates to broad spectrum antiseptic or antimicrobial compositions that may be coated or impregnated on medical articles.

### RELATED APPLICATIONS

The present invention claims priority to U.S. Provisional Application No. 61/909,851 filed on Nov. 27, 2013 and titled “Non-Sticky Antimicrobial Medical Articles,” the contents of which is herein incorporated by reference in its entirety.

### FIELD OF THE INVENTION

The present invention relates to broad spectrum antiseptic or antimicrobial compositions that may be coated or impregnated on medical articles.

### BACKGROUND OF THE INVENTION

CHG is a widely used antimicrobial agent for coating medical articles. It is effective on both Gram-positive and Gram-negative bacteria as well as fungi and viruses. Although medical articles coated with CHG are well known, there are certain drawbacks associated with the use of CHG. For example, CHG has a high tendency to stick to skin as well as substrates such as gloves. This stickiness or tackiness of CHG is undesirable, especially when CHG is used as a coating for gloves. For example, CHG-coated gloves stick to each other and to the packaging box making it difficult for a user to pull them apart. Moreover, the gloves may tear off as the user tries to separate them from each other or take them out of a box. Thus, it is inconvenient and cumbersome for a user to handle gloves or other medical articles coated with a CHG-containing coating. Thus, there is a need for antimicrobial gloves and medical articles that are non-sticky and easy to handle.

### SUMMARY OF THE INVENTION

The present invention provides antimicrobial compositions and medical articles coated with them.

In one embodiment, the antimicrobial composition comprises a chlorhexidine salt at a concentration of about 1% to about 19% and a silicone or its derivative at a concentration of about 1% to about 15%. The chlorhexidine salt that may be used in the compositions of the invention include, but are not limited to, chlorhexidine gluconate, chlorhexidine acetate, chlorhexidine palmitate, chlorhexidine succinate, chlorhexidine diisobutyrate, chlorhexidine diphosphanilate, and chlorhexidine dihydrochloride. In a particular embodiment, the chlorhexidine salt is chlorhexidine gluconate. The silicone or its derivative that may be used in the compositions of the invention include, but are not limited to, dimethicone, cyclomethicone, and dimethiconol.

The antimicrobial composition according to the invention may further comprise medically acceptable excipients such as glycerin and other medically acceptable agents, such as wetting agents, pH adjusting agents, anti-foaming agents, etc. In one embodiment, the antimicrobial composition of the invention is a water-based composition comprising a chlorhexidine salt, a silicone or its derivative, in combination with other excipients and agents.

In another embodiment, the antimicrobial composition according to the invention may comprise a chlorhexidine salt at a concentration of about 1% to about 19% and diheptyl acetate and capryloyl glycerin/sebacic acid copolymer, wherein the concentration of diheptyl succinate together with the capryloyl glycerin/sebacic acid copolymer is about 1% to about 15%.

In some embodiments, the antimicrobial composition of the invention may comprise a dye. The dye may be bonded to the chlorhexidine salt. In an embodiment, the chlorhexidine salt and the dye are bonded ionically to form the antimicrobial compound. In another aspect, the chlorhexidine salt and the dye are bonded covalently to form the antimicrobial compound. The chlorhexidine salt and the dye may be combined in any amount in the antimicrobial composition of the invention.

In certain embodiments, the dye can be a triarylmethane dye, a monoazo dye, a diazo dye, an indigoid dye, a xanthene or a fluorescein dye, an anthraquinone dye, or a quinoline dye. In other specific embodiments, the dye is gentian violet, or crystal violet, ethyl violet, brilliant green, an FD&C dye, or a D&C dye. In one example, the FD&C dye is Blue No. 1 or Green No. 3. In another example, the triarylmethane dye is gentian violet. In yet another example, the monoazo dye is FD&C Yellow No. 5 or FD&C Yellow No. 6. In still another example, the diazo dye is D&C Red No. 17. The indigoid dye, may preferably be FD&C Blue No. 2. An example of a xanthene dye is FD&C Red No. 3, of an anthraquinone dye is D&C Green No. 6 and an example of a quinoline dye is D&C Yellow No. 1. In an embodiment, the dye may be selected from the dyes disclosed in Table 1 of U.S. Patent No. 7,713,472, which is hereby incorporated by reference herein in its entirety. One of skill in the art will recognize that these examples are non-limiting and that the antimicrobial compositions of the present invention can be made using almost any dye.

The invention also encompasses antimicrobial compositions comprising suitable substitutes or equivalents of chlorhexidine. For example, suitable substitutes of chlorhexidine include, but are not limited to, alexidine, hexamidine.

In one embodiment, the invention provides medical articles coated with the antimicrobial compositions of the invention. Medical articles that may be coated with the antimicrobial compositions of the invention include, but are not limited to, gloves, surgical instruments, dental care instruments, dental consoles, instrument trays, catheters, urological devices, blood collection and transferring devices, medical and dental implants, implantable prostheses, surgical sutures, stents, ophthalmic devices, intraocular lenses, tracheotomy devices, topical disinfectants, and wound dressings. The invention also encompasses non-medical gloves, such as food-contact gloves and industrial or household gloves that may be coated with the antimicrobial compositions of the invention.

The invention also provides methods for coating a medical article with the antimicrobial compositions of the invention. In one embodiment, the method for coating a medical article comprises applying the antimicrobial composition of the invention to the medical article. The antimicrobial composition of the invention may be applied to medical articles by dipping, spraying, or other means known in the art. In one embodiment, the antimicrobial coating is applied to the outer surface of a medical article. By outside surface is meant the portion of the medical article that comes into contact with other objects such as patients, medical instruments, table tops, or counters. The antimicrobial composition of this invention can also be applied to the inside surface of a medical article, such as a surgical or examination glove. By inside surface is meant the surface that comes into contact with the wearer's hand or skin.

In one embodiment, the invention provides a medical article coated with an antimicrobial composition, wherein the antimicrobial composition reduces or prevents sticking of a medical article to other medical articles or surfaces. For example, in a particular embodiment, the antimicrobial composition of the invention, when applied to gloves, reduces or prevents sticking of gloves to each other or to a container holding the gloves.

### DETAILED DESCRIPTION OF THE INVENTION

The present invention provides antimicrobial compositions that may be used to coat medical articles such as gloves. In one embodiment, the antimicrobial compositions of the invention reduce or prevent sticking of gloves to other surfaces.

In an embodiment, the antimicrobial composition of the invention comprises a chlorhexidine salt and a silicone or its derivative in combination with suitable excipients. The concentration of the chlorhexidine salt in the composition may vary from about 1% to about 19%, for example, from about 2% to about 17%, or from about 5% to about 15%, or from about 7% to about 13%, or from about 8% to about 12%. In some embodiments, the concentration of the chlorhexidine salt in the composition is about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, or about 19%, inclusive of all ranges and subranges therebetween. In a particular embodiment, the concentration of the chlorhexidine salt in the composition is about 15% or about 17%.

The concentration of the silicone or its derivative in the composition may vary from about 1% to about 15%, for example, from about 2% to about 14%, or from about 5% to about 12%, or from about 8% to about 10%. In some embodiments, the concentration of the silicone or its derivative in the composition is about 1%, about 2%, about 3%, about 4%, about 5%, about 6%, about 7%, about 8%, about 9%, about 10%, about 11%, about 12%, about 13%, about 14%, or about 15%, inclusive of all ranges and subranges therebetween. In a particular embodiment, the concentration of the silicone or its derivative in the composition is about 10%, about 12%, about 14%, or about 15%.

The ratio of a chlorhexidine salt to a silicone or its derivative may vary from about 15:1 to about 2:1, or from about 12:1 to about 5:1, or from about 10:1 to about 8:1. In a particular embodiment, the ratio of a chlorhexidine salt to a silicone or its derivative is about 6:1. In still other embodiments, the ratio of a chlorhexidine salt to a silicone or its derivative is about 5:1,about 6:1, about 7:1, about 8:1, about 9:1, or about 10:1, inclusive of all ranges and subranges therebetween.

In another embodiment, the antimicrobial composition according to the invention comprises a chlorhexidine salt, diheptyl acetate and capryloyl glycerin/sebacic acid copolymer in combination with suitable excipients. The concentration of the chlorhexidine salt in the composition may vary from about 1% to about 19%, for example, from about 2% to about 17%, or from about 5% to about 15%, or from about 7% to about 13%, or from about 8% to about 12%. In some embodiments, the concentration of the chlorhexidine salt in the composition is about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, or about 19%, inclusive of all ranges and subranges therebetween. In a particular embodiment, the concentration of the chlorhexidine salt in the composition is about 15% or about 17%.

The concentration of diheptyl succinate together with capryloyl glycerin/sebacic acid copolymer may vary from about 1% to about 15%, for example, from about 2% to about 14%, or from about 5% to about 12%, or from about 8% to about 10%. In some embodiments, the concentration of diheptyl succinate together with capryloyl glycerin/sebacic acid copolymer in the composition is about 1%, about 2%, about 3%, about 4%, about 5%, about 6%, about 7%, about 8%, about 9%, about 10%, about 11%, about 12%, about 13%, about 14%, or about 15%, inclusive of all ranges and subranges therebetween. In a particular embodiment, the concentration of diheptyl succinate together with capryloyl glycerin/sebacic acid copolymer in the composition is about 10%, about 12%, about 14%, or about 15%.

In some embodiments, the antimicrobial composition of the invention may comprise a dye, such as gentian violet, crystal violet, brilliant green and the like. The concentration of the dye in the antimicrobial composition may vary from about 0.0001% to about 1.0% or from about 0.001% to about 1.0% or from about 0.01% to about 1.0%. In particular embodiments, the concentration of the dye is about 0.0001%, about 0.0003%, about 0.0005%, about 0.0007%, about 0.001%, about 0.003%, about 0.005%, about 0.007%, about 0.01%, about 0.03%, about 0.05%, about 0.07%, about 0.1%, about 0.3%, about 0.5%, about 0.7%, or about 1.0%, inclusive of all ranges and subranges therebetween.

The chlorhexidine salt and the dye may be combined in any amount in the antimicrobial composition of the invention. For example, in an embodiment, the antimicrobial composition comprises an equimolar amount of the chlorhexidine salt and the dye. In some embodiments, the molar ratio between the dye and the chlorhexidine salt is 1:1, 1:2, 1:3, 1:4, 1:5, 1:6, 1:7, 1:8, 1:9, 1:10, 1:15, 1:20, 1:25, 1:30, 1:35, 1:40, 1:45, 1:50, 1:55, 1:60, 1:65, 1:70, 1:75, 1:80, 1.85, 1:90, 1:95, or 1:99 of either dye:chlorhexidine salt or chlorhexidine salt:dye. This includes all the intermediate ranges and subranges as well, for example it includes molar ratios such as, 1.1:1, 1.2:1, 1.3:1, 1.4:1, 1.5:1, 1.6:1, 1.7:1, 1.8:1, 1.9:1 and the like for other values listed.

### EXAMPLES

Preparation of antimicrobial compositions and coating of gloves:

An antimicrobial composition for coating gloves was prepared by mixing a desired amount of 20% chlorhexidine gluconate solution with a desired amount of silicone or its derivative followed by addition of glycerin, other excipients, and purified water. The solution was stirred continuously to achieve uniform mixing. The uniformly mixed solution was applied to gloves by dipping or spraying techniques disclosed in U.S. Pre-grant Publication No. 2005/0186258, which is hereby incorporated by reference herein in its entirety.

The following compositions were prepared:

| 1) | % concentration |
|---|---|
| Chlorhexidine Gluconate | 1-19 |
| Dimethicone | 1-15 |
| Glycerin and other excipients | 0.1-5 |
| Purified water | to 100% |

| 2) | % concentration |
|---|---|
| Chlorhexidine Gluconate | 1-19 |
| Cyclomethicone | 1-15 |
| Glycerin and other excipients | 0.1-5 |
| Purified water | To 100% |

| 3) | % concentration |
|---|---|
| Chlorhexidine Gluconate | 1-19 |
| Dimethiconol | 1-15 |
| Glycerin and other excipients | 0.1-5 |
| Purified water | To 100% |

| 4) | % concentration |
|---|---|
| Chlorhexidine Gluconate | 1-19 |
| Diheptyl succinate and capryloyl | 1-15 |
| glycerin-sebacic acid copolymer | |
| Glycerin and other excipients | 0.1-5 |
| Purified water | To 100% |

| 5) | % concentration |
|---|---|
| Chlorhexidine Gluconate | 1-19 |
| Dimethicone/Cyclomethicone/Dimethiconol | 1-15 |
| Gentian Violet/Crystal Violet/Brilliant Green | 0.0001 to 1.0% |
| Glycerin and other excipients | 0.1-5 |
| Purified water | to 100% |

| 6) | % concentration |
|---|---|
| Chlorhexidine Gluconate | 1-19 |
| Diheptyl succinate and capryloyl glycerin- | 1-15 |
| sebacic acid copolymer | |
| Gentian Violet/Crystal Violet/Brilliant Green | 0.0001 to 1.0% |
| Glycerin and other excipients | 0.1-5 |
| Purified water | to 100% |

I claim:

1. An antimicrobial composition comprising:
a. a chlorhexidine salt at a concentration of about 1% to about 19%;
b. a silicone and/or its derivative at a concentration of about 1% to about 15%; and
c. one or more medically acceptable excipients.

2. The antimicrobial composition according to claim 1, wherein the chlorhexidine salt is selected from the group consisting of chlorhexidine gluconate, chlorhexidine acetate, chlorhexidine palmitate, chlorhexidine succinate, chlorhexidine diisobutyrate, chlorhexidine diphosphanilate, and chlorhexidine dihydrochloride.

3. The antimicrobial composition according to claim 1, wherein the silicone and its derivative are selected from the group consisting of dimethicone, cyclomethicone, and dimethiconol.

4. The antimicrobial composition according to claim 1, wherein the medically acceptable excipient is glycerin.

5. The antimicrobial composition according to claim 1, wherein the composition is applied as a coating on a medical article.

6. The antimicrobial composition according to claim 5, wherein the composition, when applied as a coating to a medical article, reduces or prevents sticking of the medical article to other surfaces.

7. An antimicrobial medical article comprising a medical article coated with an antimicrobial composition according to claim 1.

8. A method for preparing an antimicrobial medical article comprising applying the antimicrobial composition according to claim 1 to a medical article.

9. The method according to claim 8, wherein the antimicrobial composition is applied to an external surface of the medical article.

10. The method according to claim 8, wherein the antimicrobial composition is applied to the medical article by spraying or dipping.

11. The antimicrobial medical article according to claim 7, wherein the medical article is selected from the group consisting of: gloves, surgical instruments, dental care instruments, dental consoles, instrument trays, catheters, urological devices, blood collection and transferring devices, medical and dental implants, implantable prostheses, surgical sutures, stents, ophthalmic devices, intraocular lenses, tracheotomy devices, topical disinfectants, and wound dressings.

12. An antimicrobial composition comprising:
a. a chlorhexidine gluconate at a concentration of about 1% to about 19%;
b. diheptyl succinate;
c. a copolymer of capryloyl glycerin and sebacic acid monomers; and
d. one or more medically acceptable excipients;
wherein the concentration of diheptyl succinate together with the copolymer of capryloyl glycerin and sebacic acid monomers is about 1% to about 15%.

13. The antimicrobial composition according to claim 1, further comprising a dye selected from gentian violet or crystal violet.

14. The antimicrobial composition according to claim 12, further comprising a dye selected from gentian violet or crystal violet.
